(19) United States
(12) Patent Application Publication
(10) Pub. No.: US 2009/0094256 A1
(43) Pub. Date: Apr. 9, 2009

(54) METHOD AND SYSTEM FOR REGISTERING A DEVICE

(75) Inventors: Shaun Van Coller, Florida (ZA); Adam Ismail, Roodepoort (ZA)

Correspondence Address: SUGHRUE MION, PLLC, 2100 PENNSYLVANIA AVENUE, N.W., SUITE 800, WASHINGTON, DC, 20037, US

(73) Assignee: IT CRIMES CC, Langlaagte (ZA)

(21) Appl. No.: 12/280,912

(22) PCT Filed: Feb. 27, 2007
(86) PCT No.: PCT/IB07/50626

§ 371 Date: Sep. 24, 2008

(30) Foreign Application Priority Data
Feb. 27, 2006 (ZA) 2006/01671

(51) Int. Cl. G06F 17/30

(52) U.S. Cl. 707/10; 707/E17.032

(57) ABSTRACT

This invention relates to systems and methods for registering a device and retrieving identification information of the device. The system (10) registers unique identification information of a remote device (12) for identification of the device (12) in the event of the device (12) being stolen or lost. The system includes a central station (14), which communicates with the device (12) to receive registration information from the device (12). The system (10) includes interrogation means for sending an interrogation message to the device (12) to retrieve identification information of at least one component of the device (12). The communication channel between the remote device (12) and the central station (14) remains open while the registration information is provided and the identification information is retrieved by the central station (14). The registration and identification information is stored by the central station (14).

### INTRODUCTION AND BACKGROUND TO THE INVENTION

This invention relates to a method of and a system for registering a device and a method of and a system for retrieving identification information of a device. More specifically, this invention relates to a method and system of retrieving and registering unique identification information of a device for identification of the device in the event of the device being stolen or lost.

Computing devices such as computers, laptops, cell phones, personal digital assistants (PDAs) and the like, each have a unique serial number by which they are identified. Computer components, such as hard drives, motherboards, optical drives, flash memory and even power supplies also each have a unique serial number.

It is known to provide the serial number of a device to the police once the device has been stolen. The police therefore have a database of serial numbers of reported stolen devices, which they compare to serial numbers of recovered stolen devices.

A disadvantage of the abovementioned database is that the information provided to the police, by an owner or user of the device is not verified as being correct or that of the device alleged to have been stolen. A second disadvantage of this database is that, since the serial number is provided to the police manually by the user, mistakes could be made in writing the number down.

A third disadvantage of the above database is that the owner or user usually is not in possession of all the serial numbers and identification details of all the various components located inside the body of the device.

### OBJECT OF THE INVENTION

It is accordingly an object of the present invention to provide a method of and a system for registering a device and a method of and a system for retrieving identification information of a device with which the aforesaid disadvantages can be at least partially overcome or minimised.

### SUMMARY OF THE INVENTION

According to a first aspect of the invention, there is provided a method of registering a device on a database including the steps of:
opening a communication channel between a central station and a remote device;
receiving a message from the device at a receiving means of the central station, the message including registration information;
sending an interrogation message to the device to retrieve identification information of at least one component of the device; and
storing the identification information and the registration information in a storage means of the central station.

Further according to the invention, the interrogation message is sent to the device after the communication channel has been opened.

The central station may include a server computer being in communication with a web site via a computer system network, such as the Internet, the arrangement being such that the step of opening the communication channel may include the step of allowing communication of the device with the central station over the Internet.

The method may include the step of calculating a checksum from the identification information, the registration information or both.

The registration information may include information of an authorised user of the device, an owner of the device or both.

The identification information may be a serial number of components of the device selected from the group consisting of processors, primary storage devices, secondary storage devices, peripheral devices that communicate with a computing device, a casing of the device, hard drives, optical drives, memory, motherboard, CPU and power supply.

The identification information may further include the manufacturer, type and model of the components of the device and of the device itself.

The identification information may even further be the version of the software, firmware or application software installed on the device.

The method may include the further steps of generating and assigning an identification code to corresponding registration and identification information of the device.

The identification code may be sent to the authorised user of the device.

In the event of the device being stolen or lost, the central station may receive a report message from the authorised user of the stolen or lost device indicating that the device has been stolen or lost.

The report message may include the identification code of the user.

The method may include the further step of flagging the registration information and the identification information of the stolen or lost device as being stolen or lost.

The method may include the even further step of comparing identification information of the stolen or lost device with that of devices from other users communicating with the central station.

The method may include the even further step of comparing identification information of the stolen or lost device with identification information of another device as requested by a user of that device.

According to a second aspect of the invention, there is provided a method of registering a device on a database including the steps of:
opening a communication channel between a remote device and a central station;
sending a message from the device to a receiving means of the central station, the message including registration information; and
receiving an interrogation message from the central station that retrieves identification information of at least one component of the device to the central station.

Further according to the invention, the interrogation message is received by the device after the communication channel has been opened.

The central station may include a server computer being in communication with a web site via a computer system network, such as the Internet, the arrangement being such that the step of opening the communication channel may include the step of allowing communication of the device with the central station over the Internet.

The registration information may include information of an authorised user of the device, an owner of the device or both.

The identification information may be a serial number of components of the device selected from the group consisting of processors, primary storage devices, secondary storage devices, peripheral devices that communicate with a computing device, a casing of the device, hard drives, optical drives, memory, motherboard, CPU and power supply.

The identification information may further include the manufacturer, type and model of the components of the device and of the device itself.

The identification information may even further be the version of the software, firmware or application software installed on the device.

The user may receive an identification code corresponding to the registration and identification information of his device.

In the event of the device being stolen or lost, the authorised user of the stolen or lost device may send a report message, including the identification code, to the central station to indicate that the device has been stolen or lost.

According to a third aspect of the invention there is provided a system for registering a device comprising:
communication means for opening a communication channel with the remote device;
the communication means including receiving means for receiving a message from the device, the message including registration information;
interrogation means for sending an interrogation message to the device to retrieve identification information of at least one component of the device; and
storage means for storing the identification information and the registration information.

Further according to the invention, the interrogation means sends an interrogation message to the device after the communication channel has been opened.

The system may include a central station including the communication means, interrogation means and storage means.

The central station may include a server computer being in communication with a web site via a computer system network, such as the Internet, the arrangement being such that the communication means communicates over the Internet.

The system may include calculation means for calculating a checksum from the identification information, registration information or both.

The registration information may include information of an authorised user of the device, an owner of the device or both.

The identification information may be a serial number of components of the device selected from the group consisting of processors, primary storage devices, secondary storage devices, peripheral devices that communicate with a computing device, a casing of the device, hard drives, optical drives, memory, motherboard, CPU and power supply.

The identification information may even further be the version of the software, firmware or application software installed on the device.

The identification information may further include the manufacturer, type and model of the components of the device and of the device itself.

The central station may further include assignment means for generating and assigning an identification code to correspond registration and identification information of the device.

The communication means may send the identification code to the user.

In the event of the device being stolen of lost, the receiving means of the central station may receive a report message, including the identification code, from the authorised user of the stolen or lost device indicating that the device has been stolen or lost.

The central station may include flagging means for flagging the identification information of the stolen or lost device as being stolen or lost.

The system may further include a comparator for comparing identification information of the stolen or lost device with other devices communicating with the central station.

The comparator may further compare identification information of the stolen or lost device with identification information of another device as requested by a user of that device.

According to a fourth aspect of the invention, there is provided a method of retrieving identification information from a first remote device including the steps of:
opening a first communication channel between a storage device, having a first storage means, and a first remote device;
sending an interrogation message to the first remote device to retrieve identification information of at least one component of the first remote device;
providing the identification information to a second remote device;
opening a second communication channel between the second remote device and a central station;
sending the identification information from the second remote device to the central station; and
comparing the identification information of the first remote device to identification information stored in a second storage means of the central station.

The method may include the step of storing the identification information of the first remote device in the second storage means of the central station.

After retrieval of the identification information, it may be stored on the first storage means of the storage device.

Alternatively, the identification information may be displayed by the first remote device, such that the identification information is provided to the second remote device manually.

The central station may include a server computer being in communication with a web site via a computer system network, such as the Internet, the arrangement being such that the step of opening the second communication channel may include the step of allowing communication of the second remote device with the central station over the Internet.

Alternatively, the second remote device may be a telephone device communicating with the central station by means of a telephone network.

The method may include the step of calculating a checksum from the identification information.

The identification information may be a serial number of components of the first remote device selected from the group consisting of processors, primary storage devices, secondary storage devices, peripheral devices that communicate with a computing device, a casing of the device, hard drives, optical drives, memory, motherboard, CPU and power supply.

The identification information may further include the manufacturer, type and model of the components of the first remote device and of the first remote device itself.

The identification information may even further be the version of the software or firmware or application software installed on the device.

The identification information may even further include the location, owner, and authorised user of the first remote device.

The method may include the further steps of generating and assigning an identification code to corresponding to the identification information of the first remote device.

The identification code may be sent to the authorised user of the first remote device.

In the event of the first remote device being stolen or lost, the central station may receive a report message from the authorised user of the stolen or lost first remote device indicating that the first remote device has been stolen or lost.

The report message may include the identification code of the first remote device.

The method may include the further step of flagging the identification information of the stolen or lost first remote device as being stolen or lost.

The method may include the even further step of comparing identification information of the stolen or lost first remote device with that of devices from other users communicating with the central station.

The method may include the even further step of comparing identification information of the stolen or lost first remote device with identification information of another device as requested by a user of the first remote device.

According to a fifth aspect of the invention, there is provided a system of retrieving identification information from a first remote device comprising:
first communication means for opening a first communication channel between a storage device and a first remote device;
interrogation means for sending an interrogation message to the first remote device to retrieve identification information of at least one component of the first remote device;
a second remote device to which the identification information of the first remote device is provided; and
second communication means for opening a second communication channel between the second remote device and a central station to send the identification information of the first remote device to the central station from the second remote device.

Further according to the invention, the interrogation means sends an interrogation message to the first remote device after the first communication channel has been opened.

The central station may include a server computer being in communication with a web site via a computer system network, such as the Internet, the arrangement being such that the second communication means communicates over the Internet.

Alternatively, the second remote device may be a telephone device and the second communication means may be a telephone network, such that the second remote device communicates directly with the central station.

The storage device may be selected from the group consisting of optical discs, external hard drives and flash drives.

The storage device may include first storage means for storing the identification information of the first remote device.

The central station may include calculation means for calculating a checksum from the identification information.

The identification information may be a serial number of components of the first remote device selected from the group consisting of processors, primary storage devices, secondary storage devices, peripheral devices that communicate with a computing device, a casing of the device, hard drives, optical drives, memory, motherboard, CPU and power supply.

The identification information may even further be the version of the software, firmware or application software installed on the first remote device.

The identification information may further include the manufacturer, type and model of the components of the first remote device and of the first remote device itself.

The identification information may even further include the location, owner, and authorised user of the first remote device.

The central station may further include assignment means for generating and assigning an identification code to correspond to the identification information of the first remote device.

The central station may send the identification code to the user.

In the event of the first remote device being stolen of lost, the central station may receive a report message, including the identification code, from the authorised user of the stolen or lost first remote device indicating that the first remote device has been stolen or lost.

The central station may include flagging means for flagging the identification information of the stolen or lost first remote device as being stolen or lost.

The central station may include second storage means for storing the identification information of the first remote device.

The central station may further include a comparator for comparing identification information of the first remote device to stored identification information stored in the second storage means of the central station.

The comparator may further compare identification information of the stolen or lost first remote device with identification information of another device as requested by a user of that device.

### BRIEF DESCRIPTION OF THE DRAWINGS

Preferred embodiments of the invention will now be described by way of a non-limiting example with reference to the accompanying drawings wherein:

FIG. 1 is a block diagram of a system for registering a device;

FIG. 2 is a flowchart depicting steps in a method for registering device by using the system of FIG. 1;

FIG. 3 is an example of a web page to register the device with a central station;

FIG. 4 is an example of a web page to report the device as stolen;

FIG. 5 is an example of a web page showing the results of a search conducted to determine if a device is stolen; and

FIG. 6 is another example of the web page of FIG. 5.

### DESCRIPTION OF PREFERRED EMBODIMENTS OF THE INVENTION

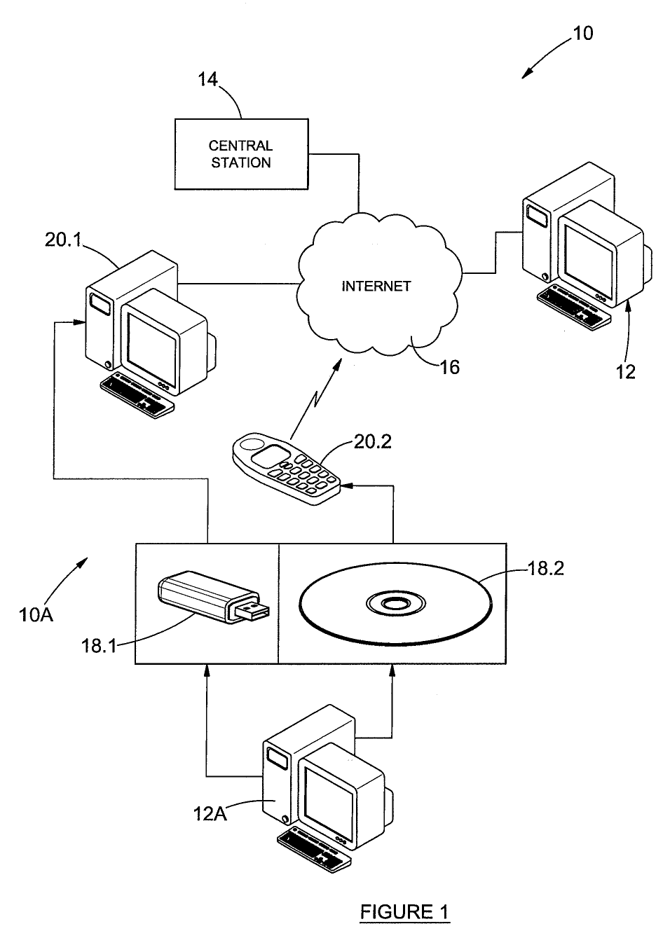

Referring to FIG. 1, a system for registering a device according to a first embodiment of the invention is generally indicated by reference numeral 10. The system 10 registers unique identification information of a remote device 12, such as a computer for identification of the device 12 in the event of the device 12 being stolen or lost.

The system includes a central station 14, which includes communication means for communicating with the device 12; the communication means including receiving means for receiving messages from the device 12, such as registration information; interrogation means for sending an interrogation message to the device 12 to retrieve identification information of at least one component of the device 12; and storage means for storing the identification information and the registration information.

The central station 14 may include a server computer being in communication with a web site via a computer system network, such as the Internet 16. The communication means thus communicates over the Internet 16 and the device 12 logs onto the Internet 16 and to the web site to communicate with the central station 14. The device 12 could log onto the Internet 16 by wireless communication means or by means of landlines. The communication channel between the device 12 and the central station 14 remains open while the interrogation message is sent to the device 12 and the registration information and the identification information is sent from the device 12 to the central station 14.

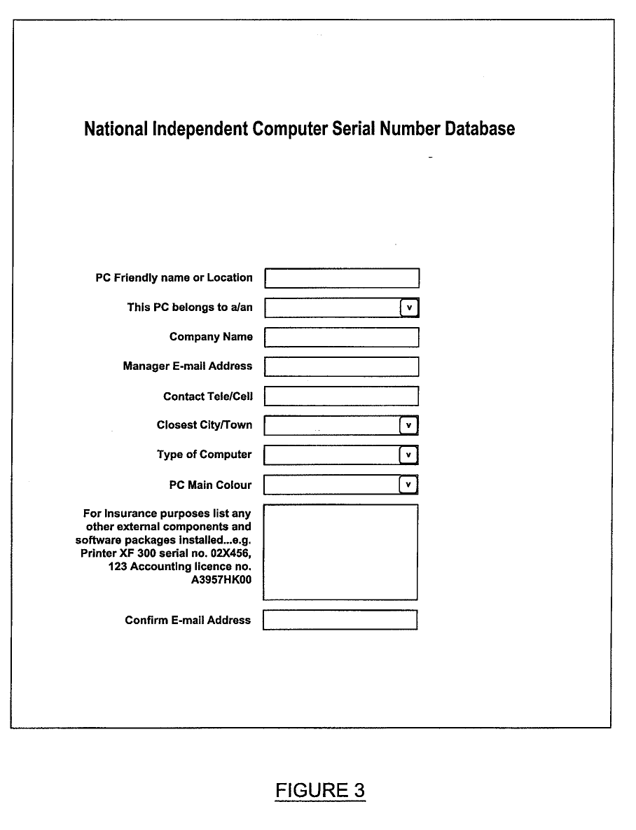

The registration information sent from the device 12 to the central station 14 includes information of an authorised user of the device 12. An example of a web page to register the device 12 with the central station 14 is shown in FIG. 3. The identification information includes serial numbers of various components of the device 12 selected from the group consisting of the processors, primary storage devices, secondary storage devices, peripheral devices that communicate with a computing device, a casing of the device, hard drives, optical drives, memory, motherboard, CPU and power supply. The identification information further includes the manufacturer, type and model of the components of the device 12 and of the device 12 itself. Even further, the identification information includes the version of the software, firmware or application software installed on the device 12.

A first example of the stored registration and identification information is as follows:

```
Return-path: <itcrimex@zukovsky.co.za>
Envelope-to: action@itcrimes.co.za
Delivery-date: Mon, 19 Feb 2007 10:18:34 +0200
    Received: from itcrimex by zukovsky.co.za with local (Exim 4.66
    (FreeBSD))
    (envelope-from <itcrimex@zukovsky.co.za>)
    id 1AB3CD-0001AB-K3
    for action@itcrimes.co.za; Mon, 19 Feb 2007 10:18:34 +0200
To: action@itcrimes.co.za
From: webmaster@zukovsky.co.za
Subject: ADD
Message-Id: <1AB3CD-0001AB-K3@zukovsky.co.za>
Date: Mon, 19 Feb 2007 10:18:34 +0200
genname: Sam
etype: Company
ename: D M K
eidnum: 1979/000871/21
eemail: sam@yahoo.com
etel: 0834568952
earea: Sandton
submit: Register
cpumake: GenuineIntel
cpuspeed: 1078Mhz
cpusn: 0000-06D8-2C04-307D-0000-0000
ramsize: 502MB
biosdate: 02/21/06
biosid: AT/AT COMPATIBLE PTLTD - 6040000
hdd1: WDC WD600UE-22HCT0 09.0 -S/N:
WD-WXE306414516
hdd2: PHILIPS CDRW/DVD SCB5265TX07
checksum: MPQKKRJXIPDHRILNM02A8A
entry point: 1010512
bios version: 2.31
bios sturcture start: 4033769472
bios sturcture count: 34
pctype: Laptop/Notebook
pccol: Grey
pcadd:
REMOTE_HOST: 196.41.206.66
REMOTE_ADDR: 196.41.206.66
HTTP_USER_AGENT: Mozilla/4.0 (compatible; MSIE 6.0; Windows
NT 5.1; SV1; .NET CLR 1.1.4322)
REMOTE_USER:
```

A second example of the stored registration and identification information is as follows:

```
Return-path: <itcrimex@zukovsky.co.za>
Envelope-to: action@itcrimes.co.za
Delivery-date: Thu, 08 Feb 2007 10:37:29 +0200
Received: from itcrimex by zukovsky.co.za with local (Exim 4.66
(FreeBSD))
    (envelope-from <itcrimex@zukovsky.co.za>)
    id 1AB3CD-0001AB-K4
    for action@itcrimes.co.za; Thu, 08 Feb 2007 10:37:29 +0200
To: action@itcrimes.co.za
From: webmaster@zukovsky.co.za
Subject: ADD
Message-Id: <1AB3CD-0001AB-K4@zukovsky.co.za>
Date: Thu, 08 Feb 2007 10:37:29 +0200
genname: Peter
etype: Individual
ename: Peter Smith
eidnum: 5201035003086
eemail: peter@hotmail.com
etel: 0863008642
earea: Randburg
136: 880815005A5A00007F041600
127: THE END!
submit: Register
cpumake: GenuineIntel
cpuspeed: 819Mhz
cpusn: 0000-06F6-0000-0000-0000-0000
ramsize: 1021MB
biosdate: 08/02/06
biosid: AT/AT COMPATIBLE TOSCPL - 6040000
hdd1: FUJITSU MHW2080BH 0000 -S/N: NZ02T6A25HJT
hdd2: SlimtypeDVDRW SSM-8515S GSL1
checksum: UYQRSRMWQTDHOHJMK02BAC
entry point: 1013664
bios version: 2.4
bios sturcture start: 901136
bios sturcture count: 23
00 bios vendor: COMPAL
00 bios version: 107B
00 bios release: 08/02/2006
00 bios physical size: 1048560
01 system manufacturer: COMPAL
01 system product: HEL80C
01 system version: *
01 system serial: 2056773500621
01 system uuid: 92ACC1CD523811DBBAAF0016D4557A98
02 board manufacturer: COMPAL
02 board product: HEL8X
02 board version: Null
02 board serial: 0123456789AB
03 chassis manufacturer: COMPAL
03 chassis type: Notebook
03 chassis version: N/A
03 chassis serial: None
03 chassis assettag: *
04 cpu socket: U2E1
04 cpu type: Central PU
04 cpu family: 02
04 cpu manufacturer: Intel
04 cpu processorid: F6060000FFFBEBBF
04 cpu version:
04 cpu externalclock: 0
07 cache socket: L1 Cache
07 cache size: 32
07 cache socket-0: L2 Cache
07 cache size-0: 4096
08 port int: J11
08 port ext: Keyboard
08 port connector: 14
08 port type: 0D
08 port int-0: J12
08 port ext-0: PS/2 Mouse
08 port connector-0: 14
08 port type-0: 0D
09 slot designation: ENE CB-714
09 slot type: PCI
09 slot databus: 05
09 slot status: Unknown
09 slot id: 0000
10 onboard type: Sound
10 onboard description: HD-Audio
11 oem string: Mustek6376MST6376
12 config string: Jumper settings can be described here.
16 mem array: 15
17 mem size: Unknown
17 mem model: SODIMM
17 mem location: M1
17 mem bank: Bank 0
17 mem type: DDR
17 mem size-0: 1024MB
17 mem model-0: SODIMM
17 mem location-0: M2
17 mem bank-0: Bank 1
17 mem type-0: DDR
19 mem address: 15
20 memd address: 19
20 memd address-0: 19
22 battery location: 1st Battery
22 battery manufacturer: COMPAL
22 battery date: 12/01/2005
22 battery serial: 3658Q
22 battery name: PA3395U
22 battery chemistry: Lithium Ion
22 battery capacity: 3150mWatt/h
22 battery volt: 14800mVolt
22 battery smart capfactor: 0A
pctype: Laptop/Notebook
pccol: Grey
pcadd: Microsoft wireless USB mous
REMOTE_HOST: 196.211.162.225
REMOTE_ADDR: 196.211.162.225
HTTP_USER_AGENT: Mozilla/4.0 (compatible; MSIE 6.0; Windows
NT 5.1; SV1)
REMOTE_USER:
```

The central station 14 further includes calculation means for calculating a checksum from the identification information and the registration identification of the device 12.

The system 10 further includes assignment means for generating and assigning an identification code to the registration and identification information of the device 12. Therefore, identification information of the device 12 and its corresponding registration information are assigned an identification code. This identification code is send to the authorised user of the device 12 for certification purposes. The following is an example of a certificate wherein the identification code assigned to this specific user is send to the user.
NICS D Certificate for Peter Smith
Certificate number: ABCDEFG-0000AB-CD
Owner ID: 1234/000123/12
Owner Name Company A
Owner Tele/Cell: 0000000000
Registration Date Mon, 19 Feb. 2007 10:18:34+0200
Note: This Certificate is valid for 7 Days from above date if NO payment is received!
There after this PC must be Re-Registered on www.itcrimes.co.za
—cut - - - cut—
Tax invoice number: ABCDEFG-0000AB-CD
Date: Feb. 19, 2007
From: IT Crimes SA (Pty) Ltd, Reg.Num.2006/026592/07
To: Company A
To activate the registration we request a cash/cheque deposit or internet transfer for Rxxxx vat inclusive.
Account Name: IT Crimes
Bank: xxxxxx
Account number: 123456789 Branch code 12345
Account type: Savings
Reference: 1234/000123/12
Note: If more than one computer is registered add up the total and make one payment.
You don't need to send a proof of payment as the NICS D system verifies automatically.
(We regret NO refunds on incorrect reference numbers)
Please Print this certificate and store in a safe place!
You can only report the computer/laptop stolen with a valid and paid certificate number!
In the unfortunate event of theft follow the following steps:
Step1: Report computer stolen at the nearest police station,
Step 2: Quote “IT Crimes-” followed by the Certificate number on the statement,
Step 3: Get the Case number,
Step 4: Go online to www.itcrimes.co.za and Report Stolen,
   You can also SMS the certificate number and case number to 000 000 0000 from the cellphone registered on the certificate (Normal Cellular Rates Apply)
We can be contacted by email: info@itcrimes.co.za or voice: 000 000 0000 NICS D Service Provided by ITCrimes® Copyright 2006

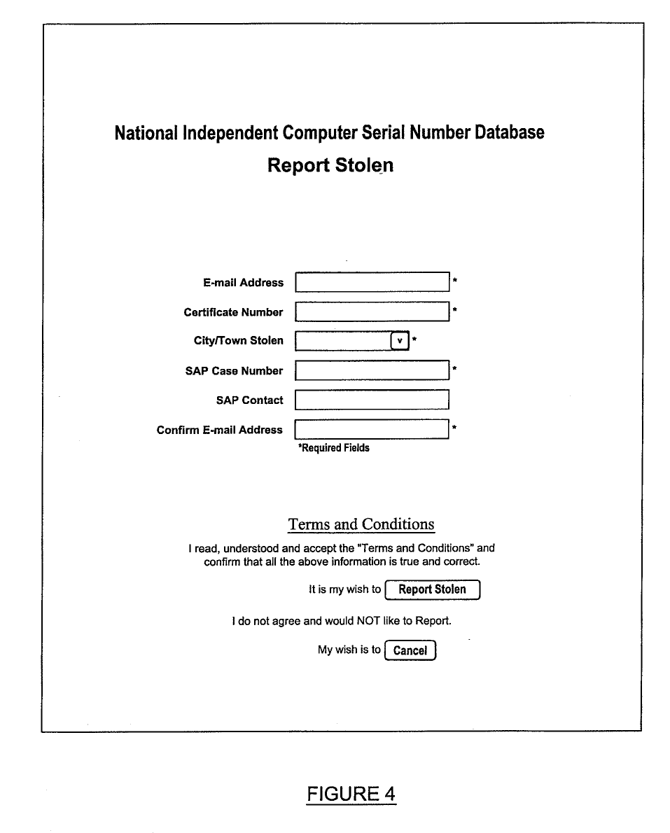

In the event of the device 12 being stolen of lost, the user sends a report message to the system's central station 14, by means of a web page over the Internet 16, as shown in FIG. 4. This report message indicates that the device 12 has been stolen or lost. The system 10 further includes flagging means for flagging the identification information of the stolen or lost device 12 as being stolen or lost.

The system 10 further includes a comparator, so that when another device communicates with the central station 14 and the system 10 retrieves that device's identification information, it compares that identification information of that device with that of the devices flagged as being stolen or lost in its database. In this manner it is possible for the system 10 to confirm whether the device or any of its components have been stolen or lost.

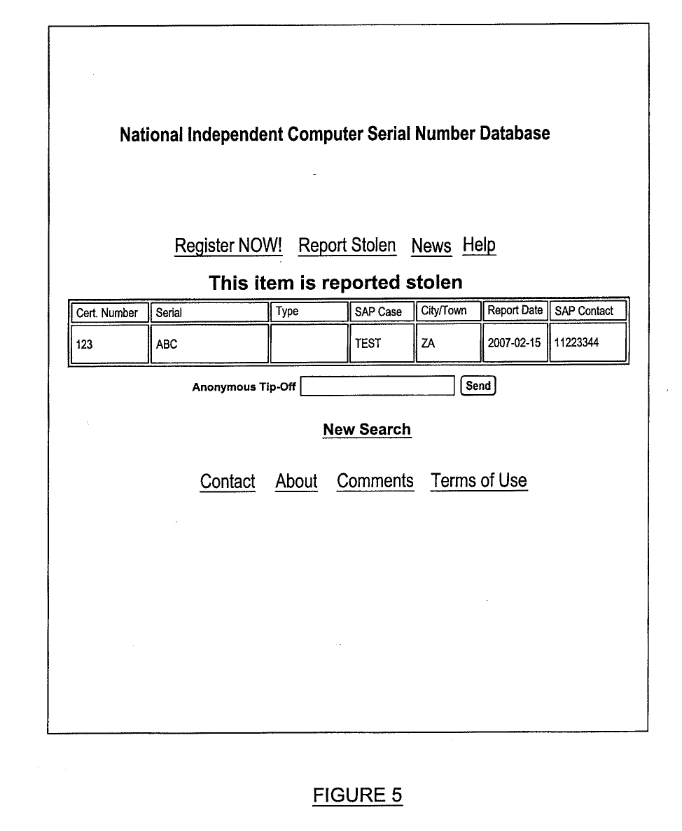

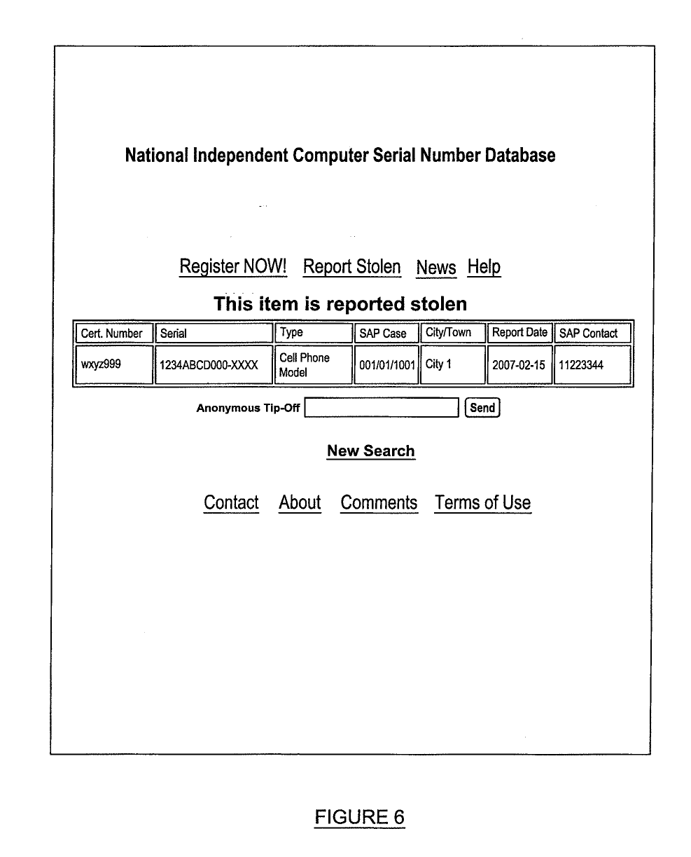

Users of the system 10 could manually verify whether or not their device 12 or its components have been reported as stolen or lost. The web pages shown in FIGS. 5 and 6 are examples of such verification. For example, a second hand dealer, authorities such as the police, or a user purchasing a second hand device, could log onto the Internet to communicate with the system and enter the identification information, which he has at his disposal, into the system. Such identification information would usually be the serial number of the device. The system 10 could also retrieve identification information from the device while the device communicates with the central station 14, as described above.

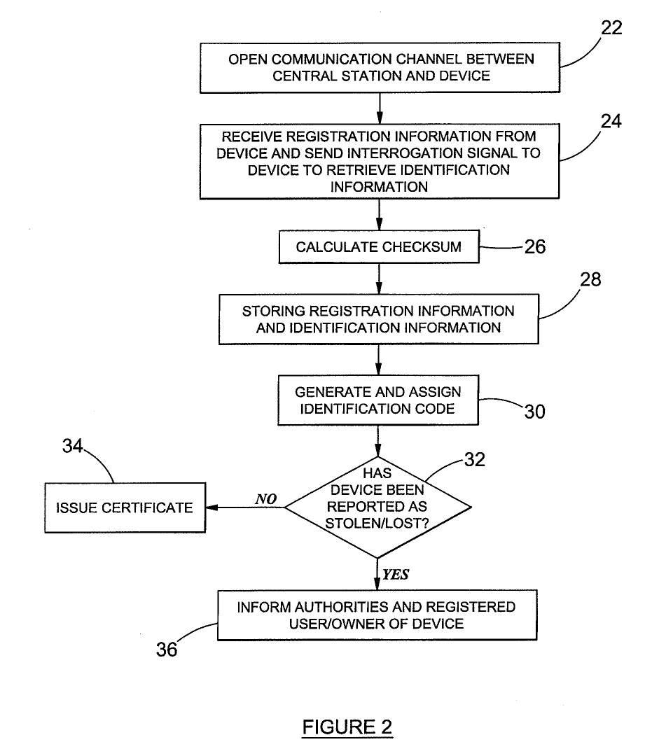

In use and by referring to the flowchart of FIG. 2, at step 22 the authorised user of the device 12 opens the communication channel between the device 12 and the central station 14 by logging onto the Internet 16 and to the web site. At step 24 and upon being prompted to do so, the user sends a message in the form of the registration information, as shown in FIG. 3, to the central station 14 from the device 12, which registration information is received by the receiving means of the central station 14. Simultaneously, the interrogation means sends the interrogation message to the device 12, which retrieves identification information from at least one component of the device 12. At the next step 26, the system 10 calculates a checksum. The registration information and identification information is stored at the central station 14 in the storage means at step 28.

Once the central station 14 has stored the registration information and the identification information, the assignment means generates and assigns an identification code to corresponding registration and identification information, at step 30. At step 32, the central station 14 compares the identification information of the device 12 to identification information already in the database of the central station to determine whether or not the device 12 might have been reported and thus flagged as stolen or lost. If it is found that the device has not been reported as lost or stolen, the identification code, in the form of a certificate, is send to the authorised user, usually by means of an email message, at step 34. If it is found that the device 12 has in fact been stolen or lost, the authorities are notified, at step 36.

In the event of the user's device 12 being stolen of lost, he reports this to the system by sending a report message to central station, as shown in FIG. 4. The user could do this by logging onto the web site and reporting his device stolen or lost and providing his identification code for authentication purposes. The identification information of this device 12 is then flagged as being lost or stolen.

In an attempt to locate the lost or stolen device, when other devices communicate with the central station 14, the system 10 retrieves those devices's identification information and compares it to the identification of the reported lost or stolen devices.

Users of the system could manually verify whether or not a device has been reported as stolen or lost. For example, second hand dealers, the police, or a user purchasing a device from someone else, could log onto the Internet and to the web site and search for the identification information in which he is interested to ascertain whether or not the device has been reported as stolen, as shown in FIGS. 5 and 6.

Further referring to FIG. 1, a system for retrieving identification information from a first remote device 12A according to a second embodiment of the invention is generally indicated by reference numeral 10A.

The system 10A includes a first communication means for opening a first communication channel between an external storage device 18.1 or 18.2 and a first remote device 12A. The external storage device 18.1 and 18.2 includes first storage means and could be an optical disc, external hard drive or a flash disc. The system 10A further includes interrogation means for sending an interrogation message from the storage device 18.1 and 18.2 to the first remote device 12A to retrieve identification information of at least one component of the first remote device 12A; a second remote device 20.1 or 20.2 to which the identification information of the first remote device 12A is provided; and a second communication means for opening a second communication channel between the second remote device 20.1 and 20.2 and a central station 14 to send the identification information of the first remote device 12A to the central station 14 from the second remote device 20.1 and 20.2.

The central station includes second storage means wherein the identification information of the first storage device could be stored. The system 10A further includes a comparator for comparing the identification information of the first remote device 12A to the identification information stored in the second storage means.

The system 10A even further includes calculation means for calculating a checksum from the identification information of the device 12A. The calculation means is present on the external storage device 18.1 and 18.2.

In use, a first communication channel is opened between the external storage device 18.1 or 18.2 and the first remote device 12A and while this first communication channel is open, an interrogation message is sent from the external storage device 18.1 or 18.2 to the first remote device 12A to retrieve identification information of at least one component of the device 12A. The identification information of the first remote device 12A is provided to a second remote device 20.1 by storing the information on the first storage means of the storage device 18.1 and taking the storage device 18.1 to the second remote device 20.1 to communicate with each other. Alternatively, the identification information of the first remote device 12A is displayed by the first remote device 12A and a user thereof, or the authorities such as the police, could manually by means of the second remote device 20.2 transfer the identification information so displayed to the central station 14. A second communication channel is thus opened between the second remote device 20.1 and 20.2 and a central station 14 and the identification information is send from the second remote device 20.1 and 20.2 to the central station 14 where it could be stored in a second storage means of the central station 14. The second remote device 20.2 could be a telephone and could communicate directly with the central station 14. The identification information of the first remote device 12A does not need to be stored in the second storage means of the central station 14, the identification information could merely be compared to stored identification information in the second storage means to determine whether or not the first remote device 12A has been lost or stolen.

The second remote device 20.1 or 20.2 communicating with the central station 14 further operates in a same manner as to the first embodiment of the invention (system 10) as described above. However, the identification information provided to the central station 14 includes information such as the location, owner, and authorised user of the first remote device.

It will be appreciated that variations in detail are possible with a method and system of registering a device and a method and system of retrieving identification information of a device according to the invention without departing from the scope of the appended claims. For example, the registration information sent from the device to the system could include information of the owner of the device or of both the owner and the authorised user.

1. A method of registering a device on a database including the steps of: opening a communication channel between a central station and a remote device; receiving a message from the device at a receiving means of the central station, the message including registration information; sending an interrogation message to the device to retrieve identification information of at least one component of the device; and storing the identification information and the registration information in a storage means of the central station.

2. A method according to claim 1 wherein the interrogation message is sent to the device after the communication channel has been opened.

3. A method according to claim 1 wherein the central station includes a server computer being in communication with a web site via a computer system network.

4. A method according to claim 3 wherein the computer system network is the Internet, the arrangement being such that the step of opening the communication channel includes the step of allowing communication of the device with the central station over the Internet.

5. A method according to claim 1 which includes the step of calculating a checksum from the identification information, the registration information or both.

6. A method according to claim 1 which includes the step of calculating a checksum from the registration information.

7. A method according to claim 1 which includes the step of calculating a checksum from the identification information and the registration information.

8. A method according to claim 1 wherein the registration information includes information of an authorised user of the device.

9. A method according to claim 1 wherein the registration information includes information of an owner of the device.

10. A method according to claim 1 wherein the registration information includes information of an authorised user of the device and of the owner of the device.

11. A method according to claim 1 wherein the identification information is a serial number of components of the device selected from the group consisting of the device selected from the group consisting of processors, primary storage devices, secondary storage devices, peripheral devices that communicate with a computing device, a casing of the device, hard drives, optical drives, memory, motherboard, CPU and power supply.

12. A method according to claim 1 wherein the identification information further includes the manufacturer, type and model of the components of the device and of the device itself.

13. A method according to claim 1 wherein the identification information even further is the version of the software, firmware or application software installed on the device.

14. A method according to claim 1 which includes the further steps of generating and assigning an identification code to corresponding registration and identification information of the device.

15. A method according to claim 14 wherein the identification code is sent to the authorised user of the device.

16. A method according to claim 15 wherein, in the event of the device being stolen or lost, the central station receives a report message from the authorised user of the stolen or lost device indicating that the device has been stolen or lost.

17. A method according to claim 16 wherein the report message includes the identification code of the user.

18. A method according to claim 16 which includes the further step of flagging the registration information and the identification information of the stolen or lost device as being stolen or lost.

19. A method according to claim 16 which includes the step of comparing identification information of the stolen or lost device with that of devices from other users communicating with the central station.

20. A method according to claim 19 which includes the step of comparing identification information of the stolen or lost device with identification information of another device as requested by a user of that device.

21. A method of registering a device on a database including the steps of: opening a communication channel between a remote device and a central station; sending a message from the device to a receiving means of the central station, the message including registration information; and receiving an interrogation message from the central station that retrieves identification information of at least one component of the device to the central station.

22. A method according to claim 21 wherein the interrogation message is received by the device after the communication channel has been opened.

23. A method according to claim 21 wherein the central station includes a server computer being in communication with a web site via a computer system network.

24. A method according to claim 23 wherein the computer system network is the Internet, the arrangement being such that the step of opening the communication channel includes the step of allowing communication of the device with the central station over the Internet.

25. A method according to claim 21 wherein the registration information includes information of an authorised user of the device.

26. A method according to claim 21 wherein the registration information includes information of an owner of the device.

27. A method according to claim 21 wherein the registration information includes information of an authorised user of the device and of the owner of the device.

28. A method according to claim 21 wherein the identification information is a serial number of components of the device selected from the group consisting of processors, primary storage devices, secondary storage devices, peripheral devices that communicate with a computing device, a casing of the device, hard drives, optical drives, memory, motherboard, CPU and power supply.

29. A method according to claim 21 wherein the identification information further includes the manufacturer, type and model of the components of the device and of the device itself.

30. A method according to claim 21 wherein the identification information even further includes be the version of the software, firmware or application software installed on the device.

31. A method according to claim 21 wherein the user receives an identification code corresponding to the registration and identification information of his device.

32. A method according to claim 25 wherein, in the event of the device being stolen of lost, the authorised user of the stolen or lost device sends a report message, including the identification code, to the central station to indicate that the device has been stolen or lost.

33. A system for registering a device comprising: communication means for opening a communication channel with the remote device; the communication means including receiving means for receiving a message from the device, the message including registration information; interrogation means for sending an interrogation message to the device to retrieve identification information of at least one component of the device; and storage means for storing the identification information and the registration information.

34. A system according to claim 33 wherein the interrogation means sends an interrogation message to the device after the communication channel has been opened.

35. A system according to claim 33 which includes a central station including the communication means, interrogation means and storage means.

36. A system according to claim 35 wherein the central station includes a server computer being in communication with a web site via a computer system network.

37. A system according to claim 36 wherein the computer system network is the Internet, the arrangement being such that the communication means communicates over the Internet.

38. A system according to claim 33 which includes calculation means for calculating a checksum from the identification information.

39. A system according to claim 33 which includes calculation means for calculating a checksum from the registration information.

40. A system according to claim 33 which includes calculation means for calculating a checksum from the registration information and the identification information.

41. A system according to claim 33 wherein the registration information includes information of an authorised user of the device.

42. A system according to claim 33 wherein the registration information includes information of an owner of the device.

43. A system according to claim 33 wherein the registration information includes information of an authorised user of the device and of an owner of the device.

44. A system according to claim 33 wherein the identification information is a serial number of components of the device selected from the group consisting of processors, primary storage devices, secondary storage devices, peripheral devices that communicate with a computing device, a casing of the device, hard drives, optical drives, memory, motherboard, CPU and power supply.

45. A system according to claim 33 wherein the identification information even further includes be the version of the software, firmware or application software installed on the device.

46. A system according to claim 33 wherein the identification information further includes the manufacturer, type and model of the components of the device and of the device itself.

47. A system according to claim 33 wherein the central station further includes assignment means for generating and assigning an identification code to corresponding registration and identification information of the device.

48. A system according to claim 47 wherein the communication means sends the identification code to the user.

49. A system according to claim 48 wherein, in the event of the device being stolen of lost, the receiving means of the central station receives a report message, including the identification code, from the authorised user of the stolen or lost device indicating that the device has been stolen or lost.

50. A system according to claim 49 wherein the central station includes flagging means for flagging the identification information of the stolen or lost device as being stolen or lost.

51. A system according to claim 50 which further includes a comparator for comparing identification information of the stolen or lost device with other devices communicating with the central station.

52. A system according to claim 51 wherein the comparator further compares identification information of the stolen or lost device with identification information of another device as requested by a user of that device.

53. A method of retrieving identification information from a first remote device including the steps of: opening a first communication channel between a first storage device and a first remote device; sending an interrogation message to the first remote device to retrieve identification information of at least one component of the first remote device; providing the identification information to a second remote device; opening a second communication channel between the second remote device and a central station; sending the identification information from the second remote device to the central station; and comparing the identification information of the first remote device to the identification information stored in a second storage means of the central station.

54. A method according to claim 53 which includes the step of storing the identification information of the first remote device in the second storage means of the central station.

55. A method according to claim 53 wherein after retrieval of the identification information, the identification information is stored on the first storage means of the storage device.

56. A method according to claim 53 wherein the identification information is displayed by the first remote device, such that the identification information is provided to the second remote device manually.

57. A method according to claim 53 wherein the central station includes a server computer being in communication with a web site via a computer system network, such as the Internet, the arrangement being such that the step of opening the second communication channel includes the step of allowing communication of the second remote device with the central station over the Internet.

58. A method according to claim 53 wherein the second remote device is a telephone device communicating with the central station by means of a telephone network.

59. A method according to claim 53 which includes the step of calculating a checksum from the identification information.

60. A method according to claim 53 wherein the identification information is a serial number of components of the first remote device selected from the group consisting of processors, primary storage devices, secondary storage devices, peripheral devices that communicate with a computing device, a casing of the device, hard drives, optical drives, memory, motherboard, CPU and power supply.

61. A method according to claim 53 wherein the identification information further includes the manufacturer, type and model of the components of the first remote device and of the first remote device itself.

62. A method according to claim 53 wherein the identification information even further includes the version of the software or firmware or application software installed on the device.

63. A method according to claim 53 wherein the identification information even further includes the location, owner, and authorised user of the first remote device.

64. A method according to claim 53 which includes the further steps of generating and assigning an identification code to correspond to the identification information of the first remote device.

65. A method according to claim 64 wherein the identification code is sent to the authorised user of the first remote device.

66. A method according to claim 65 wherein, in the event of the first remote device being stolen or lost, the central station receives a report message from the authorised user of the stolen or lost first remote device indicating that the first remote device has been stolen or lost.

67. A method according to claim 66 wherein the report message includes the identification code of the first remote device.

68. A method according to claim 67 which includes the further step of flagging the identification information of the stolen or lost first remote device as being stolen or lost.

69. A method according to claim 68 which includes the even further step of comparing the identification information of the stolen or lost first remote device with that of devices from other users communicating with the central station.

70. A method according to claim 69 which includes the even further step of comparing identification information of the stolen or lost first remote device with identification information of another device as requested by a user of the first remote device.

71. A system of retrieving identification information from a first remote device comprising: first communication means for opening a first communication channel between a storage device and a first remote device; interrogation means for sending an interrogation message to the first remote device to retrieve identification information of at least one component of the first remote device; a second remote device to which the identification information of the first remote device is provided; and second communication means for opening a second communication channel between the second remote device and a central station to send the identification information of the first remote device to the central station from the second remote device.

72. A system according to claim 71 wherein the interrogation means sends an interrogation message to the first remote device after the first communication channel has been opened.

73. A system according to claim 71 wherein the central station includes a server computer being in communication with a web site via a computer system network, such as the Internet, the arrangement being such that the second communication means communicates over the Internet.

74. A system according to claim 71 wherein the second remote device is a telephone device and the second communication means is a telephone network, such that the second remote device communicates directly with the central station.

75. A system according to claim 71 wherein the storage device is selected from the group consisting of optical discs, external hard drives and flash drives.

76. A system according to claim 71 wherein the storage device includes first storage means for storing the identification information of the first remote device.

77. A system according to claim 71 wherein the central station includes calculation means for calculating a checksum from the identification information.

78. A system according to claim 71 wherein the central station includes second storage means for storing the identification information of the first remote device.

79. A system according to claim 71 wherein the identification information is a serial number of components of the first remote device selected from the group consisting of processors, primary storage devices, secondary storage devices, peripheral devices that communicate with a computing device, a casing of the device, hard drives, optical drives, memory, motherboard, CPU and power supply.

80. A system according to claim 71 wherein the identification information even further includes the version of the software, firmware or application software installed on the first remote device.

81. A system according to claim 71 wherein the identification information further includes the manufacturer, type and model of the components of the first remote device and of the first remote device itself.

82. A system according to claim 71 wherein the identification information even further includes the location, owner, and authorised user of the first remote device.

83. A system according to claim 71 wherein the central station further includes assignment means for generating and assigning an identification code to correspond to the identification information of the first remote device.

84. A system according to claim 83 wherein the central station sends the identification code to the user.

85. A system according to claim 84 wherein, in the event of the first remote device being stolen of lost, the central station receives a report message, including the identification code, from the authorised user of the stolen or lost first remote device indicating that the first remote device has been stolen or lost.

86. A system according to claim 85 wherein the central station includes flagging means for flagging the identification information of the stolen or lost first remote device as being stolen or lost.

87. A system according to claim 86 wherein the central station includes a comparator for comparing identification information of the stolen or lost first remote device with other devices communicating with the central station.

88. A system according to claim 87 wherein the comparator further compares identification information of the stolen or lost first remote device with identification information of another device as requested by a user of that device.

89. A method of registering a device on a database according to claim 1, substantially as herein described and exemplified and/or described with reference to the accompanying figures.

90. A system for registering a device on a database according to claim 34, substantially as herein described and exemplified and/or described with reference to the accompanying figures.

91. A method of retrieving identification information from a first remote device according to claim 53, substantially as herein described and exemplified and/or described with reference to the accompanying figures.

92. A system of retrieving identification information from a first remote device according to claim 71, substantially as herein described and exemplified and/or described with reference to the accompanying figures.
